(19) United States
(12) Patent Application Publication
(10) Pub. No.: US 2020/0061879 A1
(43) Pub. Date: Feb. 27, 2020

(54) PRODUCTION METHOD FOR A COMPOSITE FACADE SYSTEM AND COMPOSITE FACADE SYSTEM

(71) Applicant: DAW SE, Ober-Ramstadt (DE)

(72) Inventors: Thomas Lohmann, Ladenburg (DE); Tobias Eichner, Worms (DE)

(21) Appl. No.: 16/549,143

(22) Filed: Aug. 23, 2019

(30) Foreign Application Priority Data
Aug. 24, 2018 (EP) 18190776.7

(51) Int. Cl. B29C 43/18; B29C 43/00; B29C 43/52; H02S 20/26; E04F 13/08

(52) U.S. Cl. CPC B29C 43/18; B29C 43/003; B29C 43/52; B29K 2105/0094; E04F 13/0801; E04F 13/0866; H02S 20/26

(57) ABSTRACT

A production method for a composite facade system with a front panel and a support layer, wherein the front panel has at least one coating surface, wherein the support layer comprises a filler, such as a lightweight filler, and a second reaction resin, the method having at least the following steps: inserting the front panel into a mold, pouring a mixture including the filler and the second reaction resin into the mold, curing the second reaction resin at a first curing temperature for a first curing time, and removing the composite facade system from the mold. The present disclosure further relates to a composite facade system.

### BACKGROUND

### Technical Field

The present disclosure provides a production method for a composite facade system, the associated composite facade system, and a use of said composite facade system.

### Description of the Related Art

Facade elements, also in the form of composite facade systems, for mounting on building walls are well known from the prior art.

DE 20 2013 102 188 U1 discloses a dry-mountable stone veneer wall panel, said panel comprising a thin stone plate and a reinforcement plate, wherein the reinforcement plate is glued to the thin stone plate.

EP 0 452 746 A1 discloses a wall facing element formed of a natural stone plate, the back side of which is glued to a ceramic plate, on the back of which fastening means are arranged for fastening the wall facing element. The fastening means extend respectively through a hole in the ceramic plate and have a thickening on the other side of the ceramic plate in a rear recess of the natural stone plate.

EP 0 277 535 A2 discloses a facade panel in the form of a composite glass pane made from a glass pane on the wall side and a pane on the visible side which are connected by a layer of plastic.

EP 0 595 062 A1 discloses a glass building component for frameless screw fastening to a support structure made from a composite glass pane comprising at least two individual glass panes, wherein the individual glass pane facing the support structure is provided in the edge area with bore holes in which a threaded metal screw connector is arranged in each instance.

EP 0 314 120 B1 discloses a facade panel for forming a facade construction for high-rising structures having a plate consisting of a single-pane safety glass in which holes are provided for receiving anchor bolts in a positive engagement. These anchor bolts project over the back of the panel and are connectable to an understructure.

EP 0 682 164 A1 discloses a facade element for a lightweight metal all-glass facade with a plate-shaped glass element which is glued on the room side to a frame construction and has blind bore holes in the outer pane which are open on the room side and extend outward and in which an anchor with a correspondingly thickened head is inserted with the intermediary of a compound so as to be rotationally locking and resistant to pushing and pulling.

DE 3 810 200 A1 discloses a building element for a facade facing for buildings which has a glass plate which is fastenable to the wall structure of the building.

WO 2006 038 804 A2 discloses an outer wall structure comprising at least one glass plate, wherein the at least one glass plate comprises at least two glass layers which are connected by at least one intermediate layer, a supporting structure for supporting the at least one glass plate, and holding means which are connected to the support structure so as to secure the at least one glass plate.

EP 1 130 183 A1 discloses a facade panel with at least one surface plate of marble, ceramic, stone, metal or steel which is fastenable to building facades, wherein the surface plate is directly foamed with a substrate layer made from foamed-on plastic.

EP 0 191 144 A2 discloses a facade panel or composite panel which comprises at least one plate-like or wall-like aerated concrete part and a layer insulating against heat, cold and sound, wherein the two parts are connected to one another over the surface area by means of a cement-based adhesive layer, and wherein a tough elastic, metal-free, corrosion-resistant fabric is embedded in the adhesive layer.

It will be appreciated from the foregoing embodiments that there is no lack of facade elements in the prior art. At the same time, it is apparent that despite the numerous disclosures in this field, improvements are certainly still possible, as concerns the production of facade elements.

One problem of the prior art is that the production of facade elements of this kind, such as composite facade systems, generally entails very high expenditure. Numerous method steps are required which drive up production costs. It is also often imperative to use materials which involve disadvantages, e.g., are very expensive, in order to ensure suitable mechanical characteristics. The adhesives employed generally have the disadvantage that they cause a higher flammability of the facades, which can jeopardize safety. However, alternatives for the above-mentioned adhesives cannot be used for many composite systems in view of the required mechanical stability, such as the internal cohesion. Also, the production of facade elements of this kind, such as of composite facade systems, is often very protracted in view of the numerous method steps, which negatively affects the quantities achievable in production.

Further, there are also disadvantages with respect to the product that is obtained. Prior art facade elements are often highly brittle throughout and can be damaged easily. Since these facade elements should generally adhere to the building wall for several years or decades, this is an important aspect. The facade elements are also generally as light as possible for safety reasons among others. However, this cannot be achieved with many facade elements of the prior art.

It is also disadvantageous when the holding systems are exposed to atmospheric conditions. Apart from detracting visually, there is a greater risk in this case that they will be damaged by, for example, corrosion or mechanical influences.

A further disadvantage in numerous conventional systems, as mentioned above, is their flammability. Facade fires are dangerous in case of fires in high buildings, and it is advantageous that the materials used in the facades do not burn easily. However, this cannot be guaranteed in many of the prior art composite facade systems, e.g., in view of the requirements mentioned above. They often cannot be utilized on high rise buildings.

It is accordingly noted that facade elements, such as composite facade systems, are high-tech products which must satisfy numerous requirements simultaneously and should ideally be producible quickly, inexpensively and efficiently all at the same time. This is a persisting problem in the prior art which allows for improvements in many respects.

Accordingly, there is a need for a production method for composite facade systems which is improved with respect to the above-mentioned disadvantages. There is also a need for an improved production method for composite facade systems with better fire safety. And, there is a need for an improved composite facade system which can be obtained through the aforementioned production method.

### BRIEF SUMMARY

In various embodiments, disclosed herein is a production method for a composite facade system with a front panel and a support layer, wherein the front panel comprises at least one coating surface, wherein in some cases a first reaction resin, in some further cases a cured reaction resin, connects the front panel and the support layer, in some cases wherein the above-mentioned first reaction resin forms a connection layer, wherein the support layer comprises a filler, in some cases a lightweight filler, and a second reaction resin, a cured reaction resin, the method having the following steps, such as in this sequence:

0) optionally inserting a nonstick foil and/or nonstick mat into a mold, in some cases a press mold,

1) inserting the front panel, in some cases preheated front panel, into the mold, in some cases a preheated mold, in some cases the press mold, in some further cases wherein the front panel is coated with a first reaction resin, in some cases liquid reaction resin, or is coated with the latter after said insertion, in some cases on a back side of the front panel, wherein the front panel is supported in the mold by an opposite front side,

2) pouring of a mixture, in some cases paste, comprising a filler, in some cases lightweight filler, and a second reaction resin into the mold, in some cases into the press mold, in some further cases poured by applying to the front panel and/or the first reaction resin, in some cases liquid reaction resin,

3) optionally inserting, into the mold, placeholders and/or fastening devices for suspending the composite facade system at a building wall, in some cases placeholders and/or fastening devices in the form of metal elements or plastics elements, which are in some further cases adapted to the shape of the mounting, in some cases into the mixture with the filler and the second reaction resin,

4) optionally providing the mold in a press, in some cases inserting the press mold into a press after depositing a pressing plate, such as on the mixture, in some cases paste, with the filler and the second reaction resin, and bringing together of the press, in some further cases until the support layer has a mean layer thickness,

5) curing the second reaction resin, in some cases the first reaction resin and second reaction resin, at a first curing temperature for a first curing time, in some cases in the press which has been heated to the first curing temperature, in some other cases under a molding pressure,

6) optionally post-curing the first reaction resin and/or second reaction resin at a second curing temperature and for a second curing time, in some cases wherein the second curing temperature is lower than the first curing temperature and the second curing time is longer than the first curing time,

7) removing the composite facade system from the mold, in some cases removing the press mold from the press and removing the composite facade system from the press mold.

Surprisingly, it was shown that the composite facade system can be produced in that the filler, in some cases lightweight filler, is applied with a second reaction resin on the front panel. Accordingly, instead of two panels being connected by an adhesive as has often been described in the prior art, a support layer is produced in situ on the other panel. Surprisingly, an improved adhesion can be achieved with the second reaction resin, and the conventional gluing of the panels after production can be dispensed with at the same time. Surprisingly, unevennesses and roughnesses on the front panel do not negatively affect the adhesion to the support layer. On the contrary, the support layer adheres even better when the front panel has unevennesses and roughnesses. Without being bound by theory, it is supposed that this is related to the in-situ production of the support layer, for example, where the mixture, in some cases paste, with the second reaction resin and the filler penetrates into the uneven portions and rough portions and is present there.

### DETAILED DESCRIPTION

In at least one possible configuration, the numbering of the method steps described herein also indicates the sequence of the method steps. In an alternative configuration, the sequence of method steps is indicated by the numbering with the exception of steps 2) and 3) which are switched, resulting in the sequence 0), 1), 3), 2), 4), 5), 6), 7). Accordingly, two configurations are valid in connection with steps 2) and 3). According to a first configuration, the placeholders and/or fastening devices are already predetermined before the mixture, in some cases paste, with the filler and the second reaction resin is poured, in some cases are fixed by means of the first reaction resin of step 1), i.e., step 3) is carried out before step 2). An especially accurate positioning is facilitated in this way. Accordingly, the above-mentioned mixture, in some cases paste, with the filler and the second reaction resin is not added until afterward.

According to a second configuration, the mixture, in some cases paste, with the filler and the second reaction resin is added first, in some cases to the first reaction resin of step 1). Subsequently, the placeholders and/or fastening devices are added; that is, step 2) is carried out before step 3). In this case, the placeholders and/or fastening means for suspending the support layer at a building wall are inserted into the mixture, in some cases paste, with the filler, in some cases lightweight filler, and the second reaction resin, in some cases liquid reaction resin. Placeholders which later serve for fastening are then already connected to the front panel by frictional engagement by the first reaction resin.

Steps 6) and 7) can also be switched so that step 7) is carried out first followed by step 6). In this case, the post-curing is carried out after the composite system has been removed from the mold. At least step 2) is, in a suitable embodiment, carried out only after step 1). In an alternative configuration, it is also possible to carry out step 1) after step 2) or step 3) in that the front panel is placed subsequently and has in another suitable embodiment been coated with the first reaction resin beforehand. The sequence of steps could then be 0), 2), 3), 1), 4), 5), 6), 7) or 0), 3), 2), 1), 4), 5), 6), 7).

The placeholders are, in some cases, placeholders for receiving the fastening means which are suitable for suspending the support layer at a building wall. They can also be placeholders which are removable. For example, they can be sleeves for fastening means, for example, sleeves with an inner thread and/or with a receiving cutout for the fastening means. It is possible to insert the fastening means only after the rest of the composite facade system has cured, which can result in an improved hold. For example, the fastening means can comprise metal and/or consist of metal, e.g., in the form of metal hooks.

The support layer is in some cases plate-shaped and in at least one configuration can also be a support plate. It is also provided in another embodiment if the side of the front panel connected to the support layer, in some cases the support plate, has less roughness than the opposite side of the front panel and/or is substantially planar. Substantially the negative mold of the back side of the front panel is, in some cases, formed on the side of the support layer, in some cases support plate, facing the front panel.

According to the present disclosure, a composite facade system is a composite system for building walls, in some cases a composite system which is usable as curtain-wall facade. In some configurations, it is provided that the composite facade system is configured and adapted to be mounted at building walls with mechanical fasteners to form a facade front. In an advisable configuration, the composite facade system comprises no more than six, in some cases no more than four, in some other cases no more than three, layers, and in some further cases exactly three layers.

A viscosity according to the present disclosure is determined at 23° C., as one-point measurement, with a Brookfield CAP 2000 cone/plate viscometer and/or at an air pressure of 1 bar. As referred to herein, a viscosity relates to a material property prior to the curing in step 5). According to the present disclosure, the fire behavior is classified according to DIN EN 13501-1:2010-01. The bulk density is suitably defined according to DIN EN 1097-3:1998-06.

According to the present disclosure, the molding pressure is the pressure actually exerted by the press. The pressure need not be uniformly distributed over the surface of the mixture, in some cases paste. In some areas, a reduction in pressure can occur if, for example, hollow spheres and/or expanded glass is destroyed to a greater degree in these areas and, in other areas without destruction, the pressure is somewhat higher. In this connection, the molding pressure is the mean pressure exerted by the press with respect to the contact surface. The molding pressure is, according to a suitable embodiment, that pressure to which the front panel proceeding from the front side and/or the mixture, in some cases paste, is exposed on average.

According to the present disclosure, the term “reaction resin” is used both for the initial mixture as well as for the cured final mixture. Further, it is used broadly to refer to both a first reaction resin and a second reaction resin unless otherwise specified. Accordingly, according to the present disclosure, reaction resins, in some cases a first reaction resin and a second reaction resin, can occupy more than one state, in some cases an uncured state, such as a liquid state, and a cured state, such as a solid state. At least an uncured state, such as the liquid state, exists prior to the curing in step 5), and the final composite system has cured reaction resins. The reaction resin or reaction resins are in some cases completely cured after step 6) at the latest. Accordingly, when reaction resins are referred to in steps 1) to 4), they are in some cases not cured. Insofar as reaction resins are referred to in the support layer obtained through the method, they are cured in step 5) and are in some cases in solid and/or elastic form. The chemical composition in the liquid state is, in some cases, not identical to the composition in the cured state, which can be traced back to the fact that the reaction resins in some cases change chemically when curing. At the same time, they can also best be characterized in the cured state via the starting product prior to curing.

A mold according to the present disclosure is, for example, a vessel or other receptacle for the front panel to which the first reaction resin and/or the second reaction resin and the filler, in some cases lightweight filler, can be added. A press mold according to the present disclosure is generally a mold which is configured and adapted to be inserted into a press or component part of a press, such as wherein the press mold withstands the molding pressure of the press. The press, in some cases, withstands a molding pressure of at least 1 N/mm², in some other cases at least 2 N/mm², in some further cases at least 3 N/mm², and in even some further cases at least 4 N/mm². Often, a pressing plate which closes the press mold and provides for a better pressure distribution is associated with the press mold. A mold with very good heat conductivity is in some cases relied on to bring about an accelerated production method with short cycle times. In this connection, the molds, in some cases press molds, that are used are formed from a material with a thermal conductivity greater than or equal to 150 W/(m·K), and in some cases greater than 200 W/(m·K). In a rather suitable embodiment of the method according to the present disclosure, the mold is formed of aluminum or copper or an aluminum alloy or a copper alloy.

In some cases, the molding pressure is greater than 1.0 N/mm², in some other cases greater than or equal to 1.5 N/mm², and in some further cases greater than 2.0 N/mm². With the method according to the present disclosure, the filler is in some cases exposed in step 4) or step 5) to a molding pressure at such a level that the filler is at least partially divided or broken up into fractions, such as when the filler comprises hollow spheres and/or expanded glass. The press mold can be combined with a pressing plate in at least one configuration, in some cases wherein the pressing plate is a corresponding complementary piece for this press mold.

The molding pressure is, in some cases, adjusted in such a way that, and maintained until, the mixture with the filler and the second reaction resin is compressed in volume by a factor of 1.05 to 3, i.e., until the volume of the mixture has been reduced by the corresponding factor. Reducing the volume of the mixture by a factor of 1.1 to 2, in some cases by a factor of 1.2 to 1.8, has proven suitable. Reducing the mean layer thickness of the mixture by a factor of 1.1 to 2, in some cases by a factor of 1.2 to 1.8, has also proven suitable.

A press according to the present disclosure can be configured and adapted to compress the contents, such as to press the press mold and pressing plate and/or to move the press mold and pressing plate toward one another. The press can, for example, be a single panel press or a double-floor panel press. The press is in some cases preheatable, for example preheatable to the first curing temperature. By “moving a press together”, it is meant that the pressing elements of the press, in some cases press dies and/or press mold and pressing plate, are moved toward one another, for example by means of a motor or hydraulically. In at least one configuration, the molding pressure ranges from 10 to 50 kg/cm², in some cases 15 to 30 kg/cm², and in some other cases 20 to 25 kg/cm².

A front panel according to the present disclosure is generally configured and adapted to form the outermost layer of a building, i.e., it generically forms the surface of a building wall of a finished building, which building wall is provided with the front panel. In this context, a front panel is in some cases configured and adapted to withstand atmospheric conditions, for example, rain, wind, hail and solar radiation. To this end, the front panel in some cases has an outer surface on the front side opposite the coating surface. In at least one configuration, it is also provided that the front panel is brightly colored, in some cases is white and/or reflective, to better deflect solar energy. This improves the energy economy of a building. Alternatively or in addition, front panels with solar cells which will generate energy and, in so doing, absorb as much solar energy as possible, are also conceivable.

In another configuration, the mold, in some cases press mold, is outfitted with a nonstick foil, in some cases Teflon foil, and/or a nonstick mat, such as a nonstick mat coated with Teflon. This is in some cases inserted prior to step 1). Alternatively or additionally, a nonstick foil, in some cases Teflon foil, is added before the pressing plate is placed on. This facilitates the removal of the final composite facade system. The nonstick foil and/or nonstick mat are in some cases flexible. A nonstick foil or a nonstick mat according to the present disclosure reduces the adhesion of the composite facade system to the mold; the removal in accordance with step 7) is facilitated. The nonstick foil and/or nonstick mat, in some cases, comprise a surface with a nonstick coating, such as polytetrafluoroethylene.

In a further configuration, it is provided that the press, in some cases in step 4), is or will be preheated to a preheating temperature, in some cases wherein the preheating temperature is closer to the first curing temperature than to a room temperature of 25° C., and/or wherein the preheating temperature substantially corresponds to the first curing temperature. This preheating temperature substantially corresponds to the first curing temperature when it is less than 20% lower or less than 20% higher, in some cases when it is less than 10% lower or less than 10% higher, than the preheating temperature. All references to temperature in the present disclosure refer to the unit of degrees Celsius. In an advisable configuration of the production method, it is provided that the press is preheated to the preheating temperature, in some cases before the front panel is inserted into the mold, in some cases press mold, in step 1). Surprisingly, this leads to better results especially as concerns the method speed. In advisable configurations, the preheating temperature amounts to 30 to 250° C., in some cases 70 to 200° C., in some other cases 100 to 160° C., in some further cases 110 to 140° C., and in even some further cases 120 to 130° C. It has been demonstrated that, in spite of an early preheating in this configuration, an uneven curing can be prevented and the curing, in some cases in step 5), takes place quickly and uniformly.

In a further embodiment, the heating of the support layer is carried out via a heated press side, while the front panel has been preheated on one side. The front panel need not be completely heated throughout. Surprisingly, it is completely sufficient when the side to be connected subsequently to the support layer is only hot on the surface. This can be achieved by infrared radiation in a preceding step. The advantage in this variant consists in a faster cycle time and in the energy saved by partial heating of the front panel.

The curing in step 5) is, in some cases, carried out accompanied by heating or temperatures appreciably above room temperature at a first curing temperature in the range of from 30 to 250° C., in some other cases from 70 to 200° C., in some further cases from 100 to 160° C., in even some further cases from 110 to 140° C., and in rather suitable further cases from 120 to 130° C. A post-curing is, in some cases, carried out in step 6) accompanied by heating or temperatures at a second curing temperature in the range of from 10 to 100° C., in some other cases from 20 to 70° C., and in some further cases from 25 to 45° C.

The filler, in some cases, consists of a lightweight filler or is a lightweight filler. A lightweight filler according to the present disclosure is a filler having a bulk density of less than 950 kg/m³. A filler, such as a mineral filler, in some cases lightweight filler, is suitably used for the present method and has a bulk density of less than 800 kg/m³, in some cases less than 600 kg/m³, in some other cases less than 500 kg/m³, and in some further cases less than 400 kg/m³. The bulk density is, in some cases, defined according to DIN EN 1097-3:1998-06. In at least one embodiment, suitable fillers, in some cases lightweight fillers, also satisfy the requirements for lightweight aggregates according to DIN EN 13055-1:2002-08.

The proportion by weight of the filler is, in some cases, greater than the proportion by weight of the second reaction resin, in some other cases greater by a multiple, for example, at least twice as great, in some further cases at least three times greater, and in even some further cases at least six times greater. The proportion of filler in the mixture, in some cases paste, added in step 2) in some cases amounts to at least 40 wt. %, and in some other cases at least 55 wt. %. The proportion by weight of filler is in some cases no more than 99.5 wt. %, and in some other cases no more than 95 wt. %.

In at least one configuration, the filler, in some cases lightweight filler, comprises or consists of an expanded volcanic rock. Alternatively or in addition, the filler, in some cases lightweight filler, can comprise, or consist of, an aluminum silicate and/or mineral hollow spheres, in some cases silicate hollow spheres, such as aluminum silicate hollow spheres. Surprisingly, foamed glass, in some cases foamed expanded glass and/or expanded glass granules, has proven especially suitable as filler, in some cases lightweight filler. Foamed expanded glass and/or expanded glass granules absorb less binder than other fillers, in some cases lightweight fillers, so that an exceptional efficiency was achieved and the proportion of second reaction resin can be minimized. It is, in some cases, provided that the filler is round or ovoid, thermally insulating, nonflammable, acoustically insulating, stable under pressure, free from grain fragments, resistant to acid and/or pest-proof. In at least one embodiment, the filler is selected from a group consisting of expanded clay, expanded schist, e.g., expanded mica schist, silicate hollow spheres, in some cases hollow glass spheres, hollow ceramic spheres, mineral expanded glass, e.g., foamed expanded glass and/or expanded glass granules, expanded perlites, expanded mica, in some cases expanded or foamed vermiculite, volcanic clinker, tuff or pumice or any mixtures thereof.

A secure and sturdy adhesion is ensured by the first reaction resin in step 1) which is rather suitable. Even without the first reaction resin in step 1), it is possible in principle to use only the second reaction resin for bonding to the front panel. Surprisingly, however, it has been shown that especially good results were achieved when a first reaction resin was applied beforehand. This is especially true when the front panel to be coated is uneven, rough and/or absorbent.

The first reaction resin in step 1) is, in some cases, a primer.

In at least one configuration, it is provided that the layer of first reaction resin, in some cases primer, is not applied (layer thickness of 0 mm) and/or, if applied, is less than 900 μm, in some cases less than 700 μm, in some other cases less than 500 μm, and in some further cases less than 300 μm. Layer thicknesses of 50 to 500 μm, in some cases 75 to 300 μm, in some other cases 100 to 200 μm, have proven to be suitable. If the first reaction resin is accordingly thinly applied or completely dispensed with, internal stresses are reduced to a considerable extent.

The relatively thick glue layers when connecting second conventional plates lead to higher stresses within the plates because the expansion coefficients of the materials differ appreciably. In the present case, however, only the expansion coefficients of the support layer and of the front panel are crucial. The latter are much more similar to each other than the expansion coefficient of the first reaction resin and/or the second reaction resin compared to the front panel.

Alternatively or in addition, it may be advisable to coat the front panel prior to step 1) with an alternative or additional primer, such as in case of absorbent front panels. When the surface of this front panel is configured such that the first reaction resin that is used can penetrate into it, the amount of reaction resin required can be reduced by using a primer, in some cases an inorganic primer. Primers are in some cases inorganic primers, dispersion-based primers, and/or reaction resin-based primers. In at least one configuration, the primer consists of waterglass polymethylmethacrylate, styrene-butadiene-acrylate and/or at least one epoxy resin. A primer including or consisting of waterglass has proven especially suitable.

In some configurations, the first reaction resin and/or the second reaction resin can have a viscosity at 23° C. of less than 1000 mPa*s, in some cases less than 500 mPa*s, in some other cases less than 300 mPa*s, and in some further cases less than 200 mPa*s when applying in step 1) or pouring in step 2). It has been demonstrated that, at this viscosity, the application of the first reaction resin in step 1) is especially efficient, i.e., in thin layer thickness and homogeneously on the coating surface. This simplifies and accelerates the method. Epoxy resins of this kind which have a glass transition temperature of at least 60° C., in some cases at least 70° C., in some other cases at least 80° C., in the cured state are especially suitable.

In some advisable configurations, the first reaction resin and/or the second reaction resin in step 1) and/or step 2), which are for example liquid, are a mixture with a first reaction resin component which is liquid and a second reaction resin component which is liquid, which first reaction resin component and second reaction resin component are blended together before applying. The first reaction resin component in some cases comprises an epoxy resin and the second reaction resin component in some cases comprises a hardener.

The first reaction resin and/or the second reaction resin are, in some cases, added simultaneously or successively to the mold as mixture, in some other cases uncured and liquid mixture, with an epoxy resin as the first reaction resin component and with a hardener, in some cases an amine, as the second reaction resin component. In at least one configuration, the first reaction resin component and the second reaction resin component are blended shortly before and/or while carrying out step 1) and/or step 2). The first reaction resin component and the second reaction resin component are in some cases first mixed and applied or poured in in step 1) and/or step 2). In this connection, it should be taken into account that the components should not yet be cured when applied or poured.

This can be monitored via the temperature and time up until application or pouring. The reaction resin components are usually mixed at room temperature, for example, and then applied or poured without a waiting period as is described in step 1) and step 2).

According to another embodiment, more of the first reaction resin component than the second reaction resin component, in some cases at least twice the amount, in some other cases at least three times the amount with respect to weight, is present in the first reaction resin. It has been shown that it is rather suitable when the total amount of the first reaction resin component is two times to five times more, in some cases three times to four times more, than the total amount of second reaction resin component. In some configurations, the weight ratio of first reaction resin component to second reaction resin component is adjusted in the range of from 200:30 to 50:30, and in some cases in the range of from 150:30 to 75:30.

The first reaction resin component, in some cases liquid reaction resin component, can be or comprises an epoxy resin, in some cases a bisphenol-based epoxy resin. According to the present disclosure, the term “epoxy resin” designates a reaction resin containing epoxy groups. A reaction resin of this kind is a liquid or liquefiable resin which hardens through polyaddition with agents such as hardeners, accelerators, and the like, without releasing volatile compounds. Suitable epoxy resins can be formed from bisphenol, in some cases bisphenol A and/or bisphenol F, and at least one epoxy compound, in some cases epichlorehydrin. In some further cases, a mixture of bisphenol A and bisphenol F is used. Other bisphenols can also be used either individually or in a mixture, in some cases in a mixture with bisphenol A and/or bisphenol F. Suitable bisphenols comprise bisphenol AF, bisphenol B, bisphenol C and bisphenol E. In an advisable embodiment, the epoxy resin is a diglycidyl ether of bisphenol A or bisphenol F or of a mixture thereof.

The second reaction resin component, in some cases, is or comprises a hardener, in some cases an amine, and in some other cases an aromatic amine or aliphatic amine. Suitable epoxy resin hardeners are, e.g., amine hardeners, in some cases selected from the group consisting of diamines, triamines, tetraamines, aliphatic polyamines and aromatic polyamines or any mixtures thereof, e.g., aminoethylpiperazine (AEP), 1,3-benzenedimethinamine (MXDA) and/or isophorone diamine (IPDA). Also among the amine hardeners to be considered are amine adducts, polyamine adducts, polyoxyalkylene diamine, polyamidoamine, Mannich bases produced through condensation of a phenol, an amine and formaldehyde, and transaminated Mannich bases. For example, 1,3-diaminobenzol and diethylenetriamine have proven suitable.

Acidic hardeners, in some cases dicarboxylic acid anhydrides, e.g., hexahydrophthalic acid anhydride, can also be used as second reaction resin component. In at least one configuration, the second reaction resin component is or comprises a liquid aliphatic polyamine and/or a liquid aliphatic polyamidoamine. The latter are suitable for curing at room temperature, also known as cold setting. Aromatic amines or acidic hardeners, for example, anhydrides of phthalic acid, are in some cases used for hot setting which is generally carried out at temperatures above 80° C.

The above-mentioned epoxy resin hardeners can be employed in the same manner for curing of reactive diluents or mixtures of epoxy resin and reactive diluent. The processing characteristics of the epoxy resin to be cured or of the setting epoxy resin can be controlled with epoxy resin hardeners, e.g., the processing time and curing time can be adjusted.

In addition to or as an alternative to the epoxy resin provided for the method, at least one reactive diluent can be added or used. The viscosity of epoxy resins, for example, based on bisphenols, can be reduced with this reactive diluent. Reactive diluents are mainly used to manipulate the processing viscosity, pot life and/or the wetting of fillers. Accordingly, in at least one configuration of the method, “reactive diluents” according to the present disclosure are viscosity-reducing substances which are chemically integrated into the resin during curing of the reaction resin. Accordingly, reactive diluents for epoxy resins are compounds of low viscosity containing epoxy groups. Therefore, suitable reactive diluents generally comprise molecular liquid epoxy functional compounds in the form of monoglycidyl ethers and diglycidyl ethers. For example, glycidyl ethers of aliphatic, alicyclic, or aromatic monoalcohols, or in some cases polyalcohols such as monoglycidyl ether, e.g., o-cresyl glycidyl ether, and/or in some cases glycidyl ether with an epoxy functionality of at least 2, such as 1,4-butanediol glycidyl ether, cyclohexandimethanoldiglycidylether, hexandiol diglycidyl ether, and/or in some cases glycidyl ethers with three or more functional groups, e.g., glycerol triglycidyl ether, pentaerythritol tetraglycidyl ether, or trimethylolpropane triglycidyl ether, or further mixtures of two or more of these reactive diluents, in some cases triglycidyl ether, and in some other cases as a mixture of 1,4-butanediol glycidyl ether and trimethylolpropane triglycidyl ether. With a two-component system of epoxy resin and epoxy resin hardener, the reactive diluent should in some cases be present only in the first reaction resin component and not in the second reaction resin component prior to mixing. In an advisable configuration, suitable reactive diluents have only one epoxy group, e.g., monofunctional glycidyl ether based on an aliphatic and aromatic alcohol. Para-tert-butylphenylglycidylether, n-butyla-glycidyl-ether, phenylglycidylether, ortho-cresyl glycidyl ether, C12-C14-glycidyl ether and 2-ethylhexyl glycidyl ether may be mentioned by way of example, while in some cases preference is given to para-tert-butylphenyl-glycidyl-ether.

The first reaction resin, in some cases, comprises the same first reaction resin component and/or the second reaction resin component as the second reaction resin. In at least one configuration, the second reaction resin has a composition that is entirely or partially identical to that of the first reaction resin.

The mixture, in some cases paste, which is added in step 2) can also comprise a hydrophobing agent, in some cases at least one silane and/or siloxane. The hydrophobing agent is, in some cases, configured and adapted to react with water accompanied by splitting off of an alcohol.

In some configurations, the coating surface has an unevennesses, such as depressions, and the first reaction resin penetrates into the unevennesses in step 1) and/or the second reaction resin penetrates into the unevennesses in step 2).

In at least one configuration of the method, the mixture which is added in step 2) is predominantly free of solvents. The proportion of solvents, if any, is in some cases less than 25 wt. %, in some other cases less than 10 wt. %, and in some further cases less than 5 wt. %, and even in some other cases less than 1 wt. %. The proportion of solvent in the mold in each of the method steps is, in some cases, less than the amounts indicated above with respect to all of the ingredients added to the mold in the method, in some other cases including the first reaction resin and second reaction resin, the filler, the photographic plate, and other components. The first reaction resin and/or the second reaction resin, in some cases, comprises less than 20 wt. % of solvent, in some other cases less than 10 wt. % of solvent, in some further cases less than 5 wt. % of solvent, and in even some further cases less than 1 wt. % of solvent. In at least one configuration, the first reaction resin and/or the second reaction resin can be free of solvents.

In at least one embodiment, the first curing time in step 5) is 20 to 10,000 seconds, in some cases 40 to 4000 seconds, in some other cases 100 to 2000 seconds, in some further cases 150 to 1000 seconds, and in even some other cases 200 to 800 seconds. It has been shown that a sufficient curing is achieved even with relatively short curing times. This considerably accelerates the method disclosed herein. In some cases the second curing time in step 6) is longer than the first curing time, in some cases at least twice as long, and in some other cases at least ten times as long.

In another embodiment, the first curing temperature in step 5) is 30 to 250° C., in some cases 70 to 200° C., in some other cases 100 to 160° C., in some further cases 110 to 140° C., and in even some further cases 120 to 130° C. These temperatures have proven suitable for a fast and efficient curing without excessive thermal stressing.

In at least one configuration, it is provided that the filler, in some cases the expanded glass, is completely or partially destroyed during the pressing in step 4). It has been shown that this can bring about a good internal cohesion. The molding pressure is, in some cases, adjusted such that at least some of the filler material in the press mold is reduced to fractions and this reduction takes place before and/or during the curing of the epoxy resin and/or reactive diluents.

In another configuration of the production method according to the present disclosure, it is provided that in step 1) less than 1.6 kg/m², in some cases less than 0.8 kg/m², in some other cases less than 0.4 kg/m², and in some further cases less than 0.25 kg/m², of the first reaction resin is applied to the coating surface of the front panel. Surprisingly, it has been shown that an excellent bonding is achieved even with a small amount of the first reaction resin. Using a small amount of the first reaction resin allows a controlled bonding and facilitates homogeneous distribution.

In at least one configuration, a fibrous material is added to, or embedded in, the first reaction resin in step 1). This can be, for example, a fibrous material with woven fibers. Glass fibers and/or carbon fibers, in some cases singulated and/or noncontinuous glass fibers, carbon fibers, or corresponding fibrous mats, have proven suitable. The layer thickness formed by the fibers is in some cases less than 2 mm, and in some other cases less than 1 mm.

In some further embodiments, the calorific value, such as per unit area, of the first reaction resin on the coating surface of the front panel is less than 16 MJ/m², in some cases less than 8 MJ/m², in some other cases less than 4 MJ/m², and in some further cases less than or equal to 3 MJ/m², in step 1). This can be adjusted through the choice of the type of reaction resin, through the filler contained therein, and the amount of reaction resin per unit area. Surprisingly, a good bonding is possible and fire safety is improved at the same time even with a calorific value of the first reaction resin, such as per unit area, of less than 3 MJ/m². The calorific value, such as per unit area, is in some cases defined according to DIN EN ISO 1716:2010-11.

In some embodiments the filler, in some cases lightweight filler, has, in its entirety or predominately, a grain size of less than 5 mm, in some cases less than 2 mm, and in some other cases less than 1 mm, based on measurements according to DIN EN 993-1:2017-04. In some further embodiments, the filler, in some cases lightweight filler, has, in its entirety or predominately, a grain size of greater than 0.1 mm, in some cases greater than 0.2 mm, and in some other cases greater than 1 mm, based on measurements according to DIN EN 993-1:2017-04. A suitable grain size is in the range of from 0.25 to 0.5 mm and a further suitable grain size is in the range of from 0.5 to 1 mm. These mean grain sizes have proven suitable for producing mechanically resistant support layers in connection with the second reaction resin. The support layers obtained in this way are in some cases flexible. In this regard, for example, fillers can also be used that have a grain size, also known as particle size fraction, in the range of from 0.1 to 0.3 mm, 0.1 to 0.6 mm, 0.1 to 0.9 mm, 0.25 to 0.5 mm, 0.25 to 1.0 mm, 0.25 to 1.5 mm, 0.5 to 1.0 mm, 0.5 to 2.0 mm, 0.5 to 3.0 mm, 1.0 to 2.0 mm, 1.0 to 4.0 mm, 1.0 to 6.0 mm, 2.0 to 4.0 mm, 2.0 to 8.0 mm, 2.0 to 12.0 mm, 4.0 to 8.0 mm, 4.0 to 12.0 mm, 4.0 to 16.0 mm, 8.0 to 16.0 mm, or 8.0 to 16.0 mm. The particle size fractions are in some cases 0.1 to 0.3 mm, 0.25 to 0.5 mm, 0.5 to 1.0 mm, 1.0 to 2.0 mm, 2.0 to 4.0 mm, 4.0 to 8.0 mm, or 8.0 to 16.0 mm. In another embodiment, the upper grain boundary differs from the lower grain boundary at most by a factor of 4, in some cases at most by a factor of 3, and in some further cases by at most a factor of 2. It will be appreciated that materials in which the lower grain boundary and upper grain boundary differ, for example, by at least a factor of 5 or at least by a factor of 10, can also be used. When determining the particle size range to be used for the structure according to the present disclosure or when determining the grain class, there is generally what are known as an undersize grain fraction and an oversize grain faction. That is, the majority of filler particles has a grain size or particle size in the range of grain classes indicated above. For determining the particle size fractions described above, the standard DIN EN 993-1:2017-04 can also be referred to. According to another embodiment, in at least one of the above-mentioned particle size ranges/grain classes, there is a maximum of 15 wt. %, in some cases a maximum of 10 wt. %, and in some other cases a maximum of 5 wt. %, of filler particles with a particle size above the upper range limit/grain boundary, and/or a maximum of 20 wt. %, in some cases a maximum of 15 wt. %, and in some other cases a maximum of 10 wt. % of filler particles with a particle size below the lower range limit/grain boundary. Of course, any mixtures of particle size fractions such as those described above can also be used as porous particulate inorganic filler materials.

The particle size fraction is generally defined by specifying two sieve sizes (sizes of the limiting sieve), e.g., the particle size fraction from 2.0 to 4.0 mm, also referred to as 2/4 mm. In this respect, the lower limiting sieve is generally designated by “d” (nominal smallest grain) and the upper limiting sieve is generally designated by “D” (nominal largest grain). In the example of the grain size fraction of 2.0 to 4.0 mm given above, “d” =2 mm and “D” =4 mm. In each particle size fraction, there is often still a proportion of oversize grains (proportions>D) and a proportion of undersize grains (proportions<d). Accordingly, the nominal smallest grain specified for designating the particle size fraction is not the smallest grain contained in the grain size fraction. Likewise, the nominal largest grain specified for designating the grain size fraction is not the largest grain of a particle size fraction. In other words, a particle size fraction also contains grains that are smaller than the nominal smallest grain as well as grains that are larger than the nominal largest grain. The values of the basic sieve set or the values of the basic sieve set and supplementary sieve sets 1 or 2 in accordance with DIN EN 13055-1:2002-08 can be referred to for the sieve sizes. In this regard, the basic sieve set consists of sieve sizes 0, 1, 2, 4, 8, 16, 31.5, and 63 mm. Supplementary sieve set 1 contains, in addition, sieve sizes 5.6, 11.2, 22.4, and 45 mm. Supplementary sieve set 2 contains, in addition to the basic sieve set, sieve sizes 6.3, 10, 12.5, 14, 20, and 40 mm. Range limits that are not whole numbers are often also rounded off.

The calorific value per unit mass of the composite facade system is, in some cases, less than or equal 3 MJ/kg as defined according to DIN EN ISO 1716:2010-11.

In another embodiment, the front panel comprises at least one nonmetallic inorganic material and in some cases consists predominantly or entirely thereof, in some other cases a nonmetallic inorganic material selected from a group consisting of glass, in some cases single-pane safety glass, stone, in some cases natural stone, ceramic, inorganic binder, in some cases cement, and in some other cases also mixtures thereof. For example, it can be a panel formed of the inorganic binder, in some cases a cement plate. In some cases preference is given to glass plates, stone plates, ceramic plates or cement plates, each plate consisting entirely or predominantly, i.e., to at least 50 wt. %, of the corresponding materials. Single-pane safety glass, natural stone and ceramic are suitable. While these materials are sometimes fragile, surprisingly robust composite facade systems are obtained when connected to the support layers.

In another configuration, the front panel comprises a mixture with nonmetallic inorganic material, in some cases filler, which is in some cases bonded with organic binder. This front panel in some rather suitable cases satisfies the requirements for nonflammability as set forth in DIN EN 13501:2010-01 A2 and A1, respectively, and/or is machinable with cutting tools, in some cases a milling cutter. In a further arrangement, the surface, in some cases visible surface, of the front panel, is varied, in some cases modulated in three dimensions after the composite body is cured, in some cases by grinding, milling, polishing, and/or burnishing. In a subsequent further step, this surface can be coated, for example, with a protective coating and/or a color coating.

In at least one configuration, the front panel is, in some cases, formed monolithically, for example, as a plate-shaped monolithic cuboid, in some cases wherein the thickness of the cuboid is less than its height and its width at least by a factor of 5, in some other cases at least by a factor of 10, and in some further cases at least by a factor of 20. It is also suitable when the front panel has at least one width side with a larger surface area than the other sides—with the exception of the opposite width side—which is completely planar, and in some cases does not have any recesses unless inevitable for reasons related to manufacture.

In at least one configuration, it can also be provided that the front panel comprises additional function components, for example, sensors, lights, in some cases LEDs, OLEDs, image display modules, cameras, intercoms, loudspeakers and/or photovoltaic cells. The front panel in some cases comprises sensors and/or lights and/or photovoltaic cells. In this regard, it is rather suitable when components, such as leads and plug systems, for the operation of the function components are embedded in the support layer in step 2).

According to another embodiment, it is provided that the front panel has a mean layer thickness of from 4 to 30 mm, in some cases 6 to 20 mm, and in some other cases 8 to 12 mm. According to a further embodiment, it is provided that the support layer has a mean layer thickness of from 4 to 140 mm, in some cases 8 to 70 mm, and in some other cases 12 to 35 mm. And, according to some further embodiment, it is provided that the press mold in step 4) is moved together until the above-mentioned mean layer thickness of 4 to 140 mm, in some cases 8 to 70 mm, and in some other cases 12 to 35 mm, results for the support layer. In another configuration, the support layer has a higher mean layer thickness than the front panel, in some cases a layer thickness that is thicker at least by a factor of 1.2, and in some further cases at least by a factor of 1.4. It is also suitable when this factor is no greater than 10, in some cases no greater than 5, and in some further cases no greater than 3. It has been shown that a support layer of this kind optimally stabilizes the composite facade system, while mean layer thicknesses that are too large are disadvantageous for safety, such as when the support layer is disproportionately heavy.

According to another embodiment, the coating surface and/or a surface of the support layer has a size of at least 0.04 m², in some cases at least 0.2 m², in some other cases at least 0.5 m², in some further cases at least 1 m², and in even some further cases at least 4 m² or at least 8 m². Further, it is provided in another embodiment that the coating surface and the above-mentioned surface of the support layer are substantially equal in size, and in some cases are two opposing surfaces which are substantially equal in size. The latter are considered to be substantially equal in size when the larger of the two surfaces is no more than 20%, in some cases no more than 10%, larger than the smaller surface.

In an advisable variant of the production method, it is provided that the composite facade system obtained in step 7) has a fire behavior classification of A2-s1 d0 or A1 according to DIN EN 13501-1:2010-01. This can be achieved by corresponding selection of the composition and amount ratios of, as the case may be, the first reaction resin, second reaction resin, filler, in some cases lightweight filler, and support layer. Surprisingly, good results were achieved with this classification. In some cases, panels which were less flawed but nevertheless improved with respect to fire safety were obtained compared to when a different classification was used.

According to a further embodiment, the first reaction resin is applied to the coating surface of the front panel in step 1) of the production method with a homogeneity such that the layer thickness of the first reaction resin, in some cases the layer of first reaction resin, can vary for a predominant portion of the coating surface, in some cases for a portion of the coating surface that accounts for at least 90% of the coating surface, or for the entire coating surface, between a maximum—e.g., local—layer thickness in this portion and a minimum—e.g., local—layer thickness in this portion, where the difference between the minimum layer thickness and the maximum layer thickness is less than 1 mm, in some cases less than 0.5 mm, in some other cases less than 0.1 mm, and in some further cases less than 0.05 mm. Surprisingly, the effect of the homogeneous application on the adhesive action is not insignificant. This effect could also have been negligible entirely due to the pressing together in the press. Surprisingly, however, this was not the case.

According to a further embodiment, the application of first reaction resin to the coating surface of the front panel is carried out in step 1) of the production method with a thinness such that the mean layer thickness of the reaction resin for a predominant portion of the coating surface, e.g., for a portion of the coating surface which accounts for at least 90% of the coating surface, or for the entire coating surface, is less than 1 mm, in some cases less than 0.5 mm, in some other cases less than 0.3 mm, in some further cases less than 0.2 mm, and in even some further cases under 0.15 mm. An excellent adhesive action and reduced flammability are achieved in this way.

The present disclosure is further directed to a composite facade system that is obtainable by way of the production method described in the foregoing.

In some cases the front panel is directly connected to the support layer, i.e., when there is no intermediate layer, or is indirectly connected to the support layer, and the intermediate layer, such as the first reaction resin, in some cases has a mean layer thickness of less than 0.9 mm, in some other cases less than 0.5 mm, in some further cases less than 0.3 mm, and in even some further cases in the range of from 50 to 250 μm. The composite facade system is, in some cases, two-ply, wherein either no first reaction resin was used during the production or this reaction resin did not form an independent layer. A three-ply composite facade system can also be provided, wherein the layer between the front layer and the support layer has a mean layer thickness of less than 0.9 mm, in some cases less than 0.5 mm.

The present disclosure is further directed to a composite facade system obtainable by way of the above-described production method, such as obtainable by means of the above-described production method comprising a front panel with a coating surface having or consisting of a nonmetallic inorganic material, in some cases further comprising a connection layer with a first reaction resin, in some cases a connection layer predominantly consisting of the first reaction resin, wherein the composite facade system further comprises a support layer with a filler, in some cases lightweight filler, and with a second reaction resin as binder for the filler, in some cases lightweight filler, wherein the first reaction resin and/or the second reaction resin connect the front panel to the support layer and are arranged therebetween, in some cases wherein the coating surface has unevennesses, in some cases depressions, in which the first reaction resin and/or the second reaction resin are present, and/or wherein the connection layer has a mass per unit area of less than 3 kg/m², and in some cases less than 1 kg/m².

In the composite facade system, panels are not glued in a conventional manner but, rather, a thin layer of uncured first reaction resin, in some cases, directly contacts an uncured second reaction resin. This produces a strong bonding of the front panel to the support layer and improves fire behavior.

The characteristics described above, for example of the front panel, support layer, filler, in some cases lightweight filler, and hydrophobing agent, are also suitable characteristics of the composite facade system. The above-described materials of the front panel, support layer, filler, in some cases lightweight filler, and hydrophobing agent are also suitable materials of the composite facade system.

In the following, only some of these characteristics will be mentioned again by way of example, although this should not be interpreted to mean that the characteristics or materials explicitly mentioned only in connection with the production method are any less significant. The intention is only to avoid unnecessary repetition.

For example, just as in the production method for the composite facade system, it is, for example, provided that the front panel comprises a nonmetallic inorganic material, and in some cases consists predominantly or entirely thereof, for example a nonmetallic inorganic material selected from a group consisting of glass, in some cases single-pane safety glass, stone, in some cases natural stone, ceramic and inorganic binder, in some cases cement, and/or when the front panel comprises photovoltaic cells, in some cases silicon solar cells. For example, it can be a panel consisting of the inorganic binder, and in some cases a cement plate. Glass plates, stone plates, ceramic plates, or cement plates are in some cases rather suitable, wherein the panels consist entirely or predominately of the corresponding materials. According to one embodiment, the front panel of the composite facade system can have a mean layer thickness of 4 to 30 mm, in some cases 6 to 20 mm, and in some other cases 8 to 12 mm, and/or the composite facade system can have a fire behavior with A2-s1 d0 or A1 classification according to DIN EN 13501-1:2010-01, and/or when the filler, in some cases lightweight filler, has, in its entirety or predominantly, a grain size of from 0.1 to 5 mm, in some cases 0.2 to 2 mm, and in some other cases 0.25 to 1 mm, according to DIN EN 993-1:2017-04. The advantages of these features have already been discussed in connection with the production method and need not be further described. Further characteristics, materials, and features follow from the description of the production method.

The characteristics of the first reaction resin and the second reaction resin in the composite facade system according to the present disclosure also follow from the production method, but it must be taken into account that they are now cured and, therefore, the viscosities and initial compositions refer to the production method for the final composite facade system and not to the final composite facade system itself. However, the cured reaction resins can also be defined by way of the starting products, since the corresponding constituents react in a chemically defined manner, and a person skilled in the art will be familiar with those starting substances to be added so as to obtain a cured reaction resin. Although an exact structural characterization of the cured reaction resin is often impossible to determine, the starting materials can nevertheless be determined. Consequently, reaction resins which are obtained by way of a mixture of the above-described first reaction resin component and second reaction resin component are rather suitable. According to another embodiment, the calorific value, per unit area, of the first reaction resin between support layer and front panel, such as per unit area, amounts to less than 16 MJ/m², in some cases less than 8 MJ/m², in some other cases less than 4 MJ/m², and in some further cases less than 3 MJ/m². According to a further embodiment, the calorific value of the composite facade system, such as per unit mass, can be less than or equal to 3 MJ/kg (as defined by DIN EN ISO 1716:2010-11).

Further characteristics, materials and features of the reaction resins follow from the description of the production method.

The present disclosure is further directed to a building facade having the described composite facade system and a building wall.

The present disclosure is further directed to the use of the product directly produced by the production method described above, such as in the form of the composite facade system, for completely or partially facing a building wall. The product directly produced by the production method described above is a composite facade system, such as in the form of the composite facade system obtained through, and only through, the claimed production method according to the present disclosure.

The present disclosure is further directed to the use of the composite facade system described above for completely or partially facing a building wall.

Surprisingly, composite facade systems with well-bonded layers are obtained when the support layer is produced in situ with the production method as has been described above. The present disclosure is characterized in that a production method was found which produces improved composite facade systems efficiently and in fewer steps. Moreover, these composite facade systems are less expensive, safer, and more robust than in the prior art. Accordingly, grinding of the back side of sawed natural stone front panels is dispensed with. Small defects such as cracks and pitting are bridged and require no preliminary machining. Surprisingly, it has been shown that varying thicknesses in the front panels can also be compensated by way of this method so as to form composite facade systems of uniform thickness. Surprisingly, a stable composite facade system with a front panel and a plate-like support layer is obtained via this method. A further advantage of the present disclosure consists in the similarity of the layers. Since the thin layer of the first reaction resin does not represent a primarily active layer, the front panel is in some cases directly, or almost directly, connected to the support layer. During temperature fluctuations, for example, this composite facade system does not tend to build up extensive tensions, which improves durability.

Further features and advantages of the present disclosure will be discerned from the following description in which an exemplary embodiment example of the present disclosure is described without the present disclosure being limited thereby.

The embodiment example of the production method for a composite facade system with a front panel and a support layer has the following steps:

a) Insertion of the front panel into a press mold. The front panel has dimensions of 300×300×8 mm and consists of natural stone. The natural stone consists of granite.

b) Wetting of one side of the natural stone with 11.25 g of the first reaction resin. The first reaction resin consists of the SIKA Biresin CR83 epoxy resin system as first reaction resin component and 2-piperazin-1-ylethylamine (e.g., SIKA Biresin CH 125-1 Part B) as second reaction resin component, where the mixture ratio amounts to 100:26.

c) Pouring of a mixture with the filler and the second reaction resin into the press mold. The filler is Poraver, where 650.6 g with a mean grain size of from 0.5 to 1.0 mm are used. The second reaction resin is the same as the first reaction resin, and 62.3 g are used. Further, the hydrophobing agent Wacker Silres BS 1702 is a constituent of the mixture.

d) Placeholders can be inserted for suspending the support layer.

e) The press mold, which is preheated to 120° C., is brought together until the thickness of the support layer amounts to 15.5 cm.

f) Then, the curing of the second reaction resin is carried out at a first curing temperature of 120° C. for a first curing time of 350 seconds.

g) Then, the composite facade system is removed from the press mold, and a post-curing for 24 hours accompanied by heating to 50° C. is optionally possible prior to or subsequent to the above-mentioned removal.

The composite facade system obtained in this manner has an adhesive tensile strength of 0.8±0.1 MPa, and the resulting aspect at rupture was approximately 95% cohesive in the support layer so that it was possible to confirm the strong adhesion between natural stone and support layer in experiments. Accordingly, the support layer itself is less stable internally than the bond between the support layer and the natural stone. This is advantageous because it counteracts breakage of the natural stone. The composite facade system further has a fire behavior with a classification of A2-s1 d0 or A1 according to DIN EN 13501-1:2010-01 and is accordingly nonflammable.

The features disclosed in the preceding description, the claims, and the embodiment examples may be of importance both individually and in any combination for the realization of the present disclosure in its various embodiments.

The various embodiments described above can be combined to provide further embodiments. All of the foreign patents, foreign patent applications, and non-patent publications referred to in this specification and/or listed in the Application Data Sheet are incorporated herein by reference, in their entirety. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A production method for a composite facade system with a front panel and a support layer, wherein the front panel has at least one coating surface, and wherein the support layer comprises a filler and a second reaction resin, the method comprising the following steps:
inserting the front panel into a mold,
pouring a mixture including the filler and the second reaction resin into the mold,
curing the second reaction resin at a first curing temperature for a first curing time, and
removing the composite facade system from the mold.

2. The production method according to claim 1, wherein:
the front panel has at least one coating surface,
the support layer comprises a lightweight filler,
the mold is a press mold,
in the pouring step, a mixture comprising the lightweight filler and the second reaction resin is poured into the press mold, and
a first reaction resin applied to the coating surface connects the front panel and the support layer,
the method further comprising:
inserting the press mold into a press after depositing a pressing plate on the mixture with the filler and second reaction resin, and bringing together of the press,
wherein in the curing step, the second reaction resin is cured at the first curing temperature for the first curing time in the press which has been heated to the first curing temperature, and
wherein in the removing step, the press mold is removed from the press and the composite facade system is removed from the press mold.

3. The production method according to claim 1, further comprising:
subsequent to the pouring step, inserting placeholders and/or fastening devices for suspending the composite facade system at a building wall into the mold.

4. The production method according to claim 2, further comprising:
subsequent to the curing step, post-curing the first reaction resin and/or second reaction resin at a second curing temperature for a second curing time.

5. The production method according to claim 2, wherein in the step of inserting the press mold into the press, the press has been preheated to a preheating temperature prior to insertion of the press mold.

6. The production method according to claim 1, wherein the first curing temperature amounts to 30 to 250° C., and/or wherein the first curing time is 20 to 10,000 seconds.

7. The production method according to claim 2, wherein in the step of inserting the front panel into the mold, less than 5 kg/m² of the first reaction resin is applied to the coating surface of the front panel, and/or the calorific value, per unit area, of the first reaction resin on the coating surface of the front panel is less than 16 MJ/m².

8. The production method according to claim 1, wherein in the pouring step, a hydrophobing agent is added.

9. The production method according to claim 2, wherein the first reaction resin and the second reaction resin are added simultaneously or one after the other to the mold as an uncured and liquid mixture with an epoxy resin as a first reaction resin component and with a hardener as a second reaction resin component.

10. The production method according to claim 1, wherein the filler has, in its entirety or predominately, a grain size of from 0.1 to 5 mm, according to DIN EN 993-1:2017-04, and/or wherein the filler is a lightweight filler which has a bulk density of less than 800 kg/m³.

11. The production method according to claim 1, wherein the front panel comprises a nonmetallic inorganic material.

12. The production method according to claim 1, wherein the front panel has a mean layer thickness of 4 to 30 mm, and/or wherein the support layer has a mean layer thickness of 4 to 140 mm.

13. The production method according to claim 1, wherein the composite facade system removed from the mold has a classification of A2-s1 d0 according to DIN EN 13501-1:2010-01.

14. The production method according to claim 2, wherein the first reaction resin and/or the second reaction resin have a viscosity at 23° C. of less than 1000 mPa*s, when applying the first reaction resin to the coating surface or pouring the mixture including the filler and the second reaction resin into the mold.

15. The production method according to claim 2, wherein the application of the first reaction resin to the coating surface of the front panel with a homogeneity is carried out such that the difference between maximum layer thickness and minimum layer thickness of the first reaction resin for a predominant portion of the coating surface is less than 3 mm, and/or in wherein the application of the first reaction resin to the coating surface of the front panel with a thinness is carried out such that the mean layer thickness or maximum layer thickness for a predominant portion of the coating surface is less than 5 mm.

16. A composite facade system obtained through the production method according to claim 1.

17. A composite facade system, comprising a front panel with a coating surface having or consisting of a nonmetallic inorganic material, a support layer with a filler, and with a second reaction resin as binder for the filler, further comprising a connection layer with a first reaction resin, wherein the first reaction resin and/or the second reaction resin connect the front panel to the support layer and are arranged therebetween.

18. The composite facade system according to claim 17, wherein the coating surface has unevennesses in which the first reaction resin and/or the second reaction resin are present.

19. The composite facade system according to claim 17, wherein:
the front panel comprises at least one nonmetallic inorganic material, and/or
the front panel comprises photovoltaic cells, and/or
the front panel has a mean layer thickness of 4 to 30 mm, and/or
the composite facade system has a fire behavior with A2-s1 d0 or A1 classification according to DIN EN 13501-1:2010-01, and/or
the filler has, in its entirety or predominantly, a grain size of from 0.1 to 5 mm according to DIN EN 993-1:2017-04.

20. Use of the composite facade system directly produced by the production method according to claim 1.
